(19) United States
(12) Patent Application Publication
(10) Pub. No.: US 2002/0154203 A1
(43) Pub. Date: Oct. 24, 2002

(54) Ink jet printer

(76) Inventor: Toru Tanaka, Niigata (JP)

Correspondence Address: McGinn & Gibb, PLLC, Suite 200, 8321 Old Courthouse Road, Vienna, VA, 22182-3817, US

(21) Appl. No.: 10/122,395

(22) Filed: Apr. 16, 2002

(30) Foreign Application Priority Data
Apr. 18, 2001 (JP) 2001-119405

(51) Int. Cl. B41J 2/01

(52) U.S. Cl. 347/104

(57) ABSTRACT

In order to provide an ink jet printer that can attain a non-blank printing operation, a sub paper guide 5 has a protrusion 5a that is protruded upwardly through a hole 4a of a main paper guide 4 and is movable along a sub scanning direction S2 and the protrusion 5a has a support plane for supporting a back surface of a paper 100 at a tip, wherein the sub paper guide 5 is further moved such that the support plane is always located blow the paper 100, depending on a position in the sub scanning direction S2 of the paper 100.

### BACKGROUND OF THE INVENTION

1. Field of the Invention

The present invention relates to an ink jet printer, and more particularly to an ink jet printer, which can carry out a non-blank printing operation on a paper.

2. Description of the Related Art

In recent years, with respect to a printing by an ink jet printer, since it is achieved the improvement in the picture quality of the ink jet printer and the popularization and the improvement of the picture quality of a digital camera and a scanner lead to the increase in market need as a device instead of a silver halide photograph system. On the other hand, in recent years, a photograph without any blank has been mainly used in the silver halide photograph.

For this reason, the market (consumer) also demands the non-blank printing with the ink jet printer. However, in the conventional technique, the blank implying the non-printable regions is brought about on four sides of a paper, as a real circumstance.

The reason is as follows. That is, when a print data is converted into a picture data having the same size as the paper size and ink is discharged from a recording head, even the slight deviation of the paper from a predetermined position causes the blank to be brought about in the printed result, correspondingly to the deviation. Also, even if the paper size is slightly larger than a predetermined size, the blank is brought about.

In order to solve this problem, it is necessary to convert an original print data into the print data having the size slightly larger than the paper size, and then carry out the printing operation, and thereby avoid an influence of the positional deviation of the paper.

By the way, the ink jet printer typically includes a paper guide protrusion for supporting a paper along feeding direction.

Tentatively, if the printing operation is carried out by converting an original print data into the print data having the size slightly larger than the paper size, the discharged ink that out from a paper end is deposited on the paper guide protrusion. When a next paper is fed, the ink deposited on the paper guide protrusion is deposited on a back surface of the paper. Thus, it is actually difficult to carry out the printing operation by converting into the print data having the size slightly larger than the paper size.

This problem will be described below with reference to FIGS. 5 and 6 showing a conventional paper feeding mechanism.

As showing with FIGS. 5 and 6, a recording head 11 is fixed to a carriage 2. An ink tank 3 is held in the carriage 2 by a tank lever 1. Also, the carriage 2 is supported on a guide shaft 6 so as to reciprocate in a main scanning direction indicated by an arrow S1.

A feed roller 8 is located upstream of the recording head 11 in a sub scanning direction indicated by an arrow S2. Then, a paper 100 is sandwiched between the feed roller 8 and a pressure roller 7, and the feed roller 8 feeds the paper 100 in a sub scanning direction.

Driving force is transmitted to the feed roller 8 through an LF (Line Feed) motor gear 13, an LF gear 14 and a feed roller gear 77 from an LF motor 12, and the feed roller 8 is rotated.

A discharging roller 9 is located at downstream of the recording head 11 in the sub scanning direction. Then, the paper 100 is sandwiched between the discharging roller 9 and a discharging pressure roller 10, and the discharging roller 9 feeds the paper 100 in the sub scanning direction.

Driving force is transmitted to the discharging roller 9 through the LF motor gear 13, the LF gear 14 and a discharging roller gear 15 from the LF motor 12, and the discharging roller 9 is rotated.

Also, a paper guide 64 is fixed between the feed roller 8 and the discharging roller 9. The paper guide 64 supports the paper 100.

On a top surface of the paper guide 64, a plurality of protrusions 64a are formed so as to be arranged parallel to each other in a main scanning direction. The protrusions 64a support the paper 100. A top surface of the protrusions 64a is located at the same height position with highest point of a circumferential plane of the feed roller 8. The top surface of the protrusions 64a supports the paper 100.

In the case of the print data having the size larger than that of the paper 100, if the ink is discharged from the recording head 11, the ink out from the paper is deposited on the protrusion 64a of the paper guide 64 supporting the paper 100 during feeding the paper 100. When a next paper 100 is fed, there may be a case that the ink deposits on a back surface of the paper 100. For this reason, actually, the size of the print data must be inevitably defined as being smaller than that of the paper size by considering the positional deviation of the paper 100 and the error of the size of the paper 100.

It is therefore an object of the present invention to provide an ink jet printer that can attain a non-blank printing operation, in which even if a paper is deviated from a predetermined position or a paper size is different from a predetermined size, a blank is never brought about in a printed result, and a back surface of the paper is never contaminated by the ink which out from the paper and deposits on a part of the ink jet printer.

### SUMMARY OF THE INVENTION

According to the present invention, an ink jet printer including: a recording head for discharging ink; a carriage for moving the recording head in a main scanning direction; and a paper feeding mechanism for feeding a paper in a sub scanning direction perpendicular to the main scanning direction, wherein the paper feeding mechanism has a feed roller for supporting a back surface of the paper and feeding it in the sub scanning direction and a paper guide for supporting the paper at downstream of the feed roller in sub scanning direction, wherein the paper guide is provided with a main paper guide and a sub paper guide, and the main paper guide has a top surface expanded over inner and outer regions of an ink discharging range of the recording head; and holes formed in at least the ink discharging range on the top surface of the main paper guide, and the sub paper guide has a protrusion that is protruded upwardly through the hole of the main paper guide and is movable along the sub scanning direction, and the protrusion has a support plane for supporting a back surface of the paper at a tip, and the sub paper guide is further moved such that the support plane is always located below the paper, depending on a position in the sub scanning direction of the paper.

Moreover, ink jet printer according to the present invention, a movable range of the protrusion of the sub paper guide is limited by a contact between the main paper guide and the sub paper guide.

Moreover, ink jet printer according to the present invention, the sub paper guide has a friction plate, the friction plate is in direct or indirect contact with the feed roller, and the sub paper guide is moved in synchronization with a rotation of the feed roller.

Moreover, ink jet printer according to the present invention, the friction plate releases a driving force from the feed roller, while the sub paper guide is in contact with the main paper guide.

Moreover, ink jet printer according to the present invention, further including a absorbing body for absorbing excessive ink that is discharged from the recording head and out from a paper, on the top surface of the main paper guide existing in an ink discharging range of the recording head and a region except the support plane in a surface of the sub paper guide existing in the ink discharging range of the recording head.

Moreover, ink jet printer according to the present invention, the top surface is expanded in a position lower than a highest point of the feed roller, and the protrusion can be rotated along the sub scanning direction.

The protrusion of the sub paper guide is always located below the paper when the printing operation is performed on a top end or a bottom end of the paper. Even if the printing operation is carried out with the print data having the size larger than the paper size in order to attain the non-blank printing operation, the ink out from the paper does not be deposited on the protrusion of the sub paper guide in direct contact with the paper. Thus, even if there is a deviation from a predetermined position of the paper or a difference of the paper size, it is possible to carry out the non-blank printing operation.

### BRIEF DESCRIPTION OF THE DRAWINGS

FIG. 1 is a perspective view showing a paper feeding mechanism (when a printing operation is performed on a top end of a paper) in an ink jet printer according to an embodiment of the present invention;

FIG. 2 is a side view showing the paper feeding mechanism shown in FIG. 1;

FIG. 3 is a perspective view showing the paper feeding mechanism (when a printing operation is performed on a bottom end) in the ink jet printer according to the embodiment of the present invention;

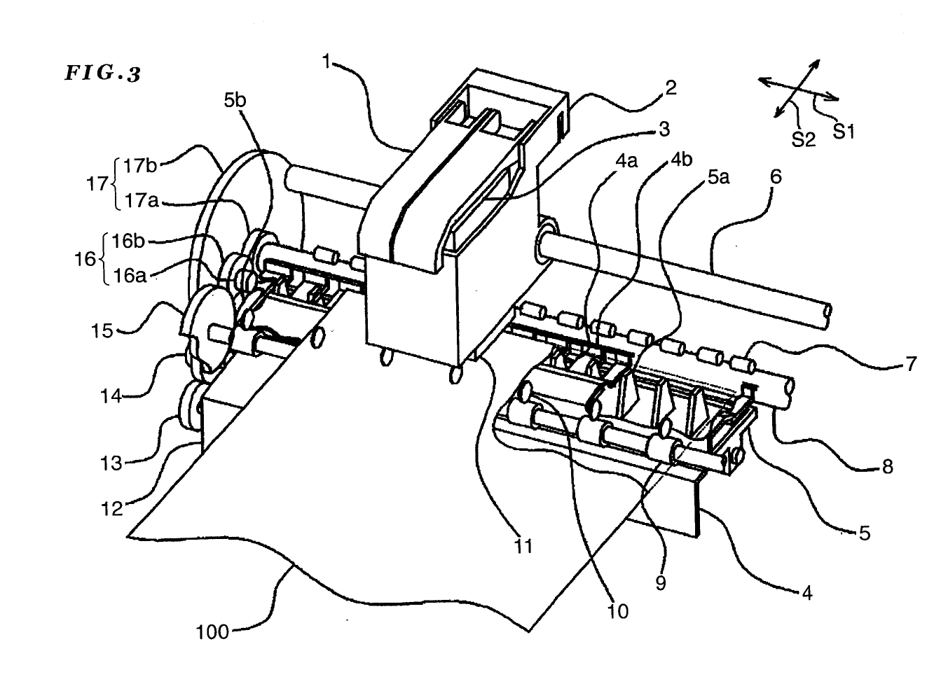

FIG. 4 is a side view showing the paper feeding mechanism shown in FIG. 3;

FIG. 5 is a perspective view showing a paper feeding mechanism (when a printing operation is performed on a bottom end) in a conventional ink jet printer; and

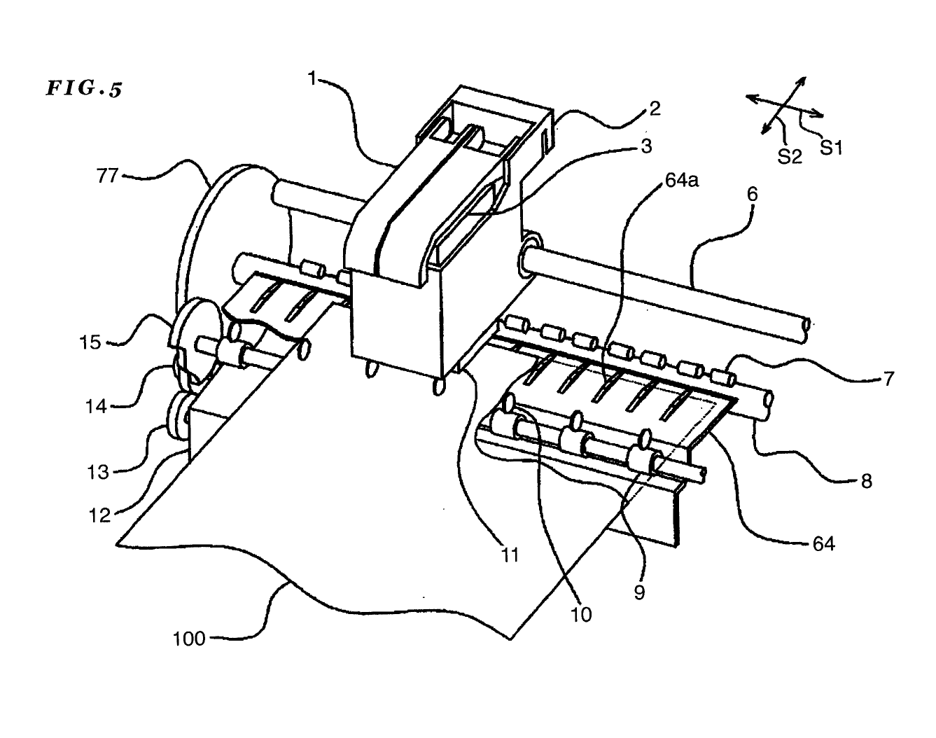

FIG. 6 is a side view showing the paper feeding mechanism shown in FIG. 5.

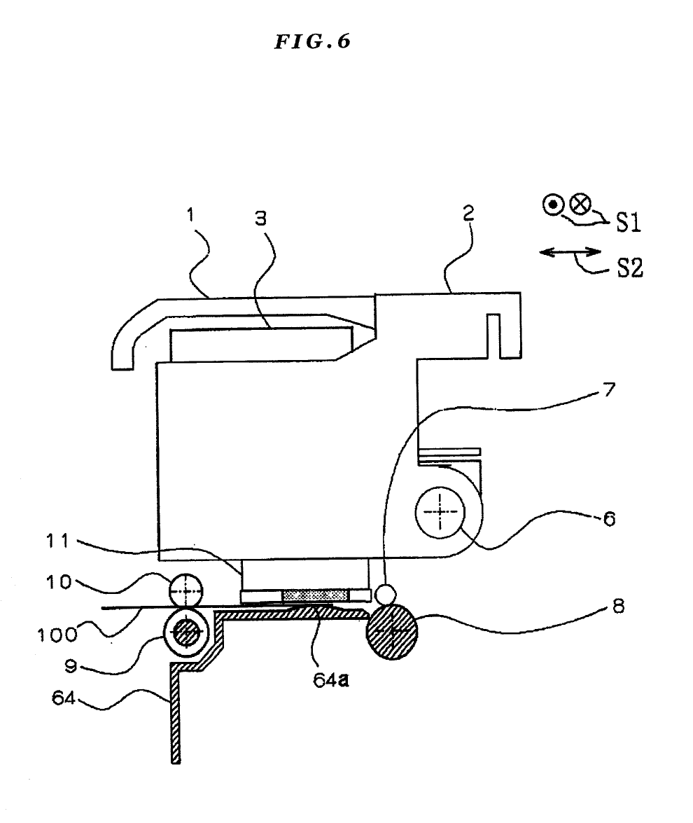

### DETAILED DESCRIPTION OF THE PREFERRED EMBODIMENT

An ink jet printer according to an embodiment of the present invention will be explained below with reference to the drawings.

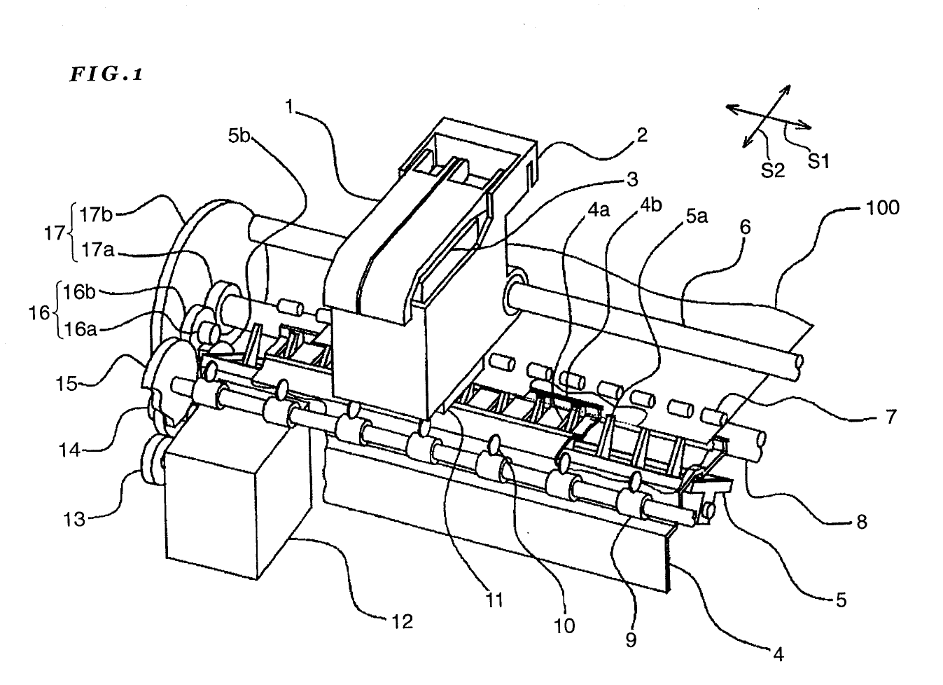

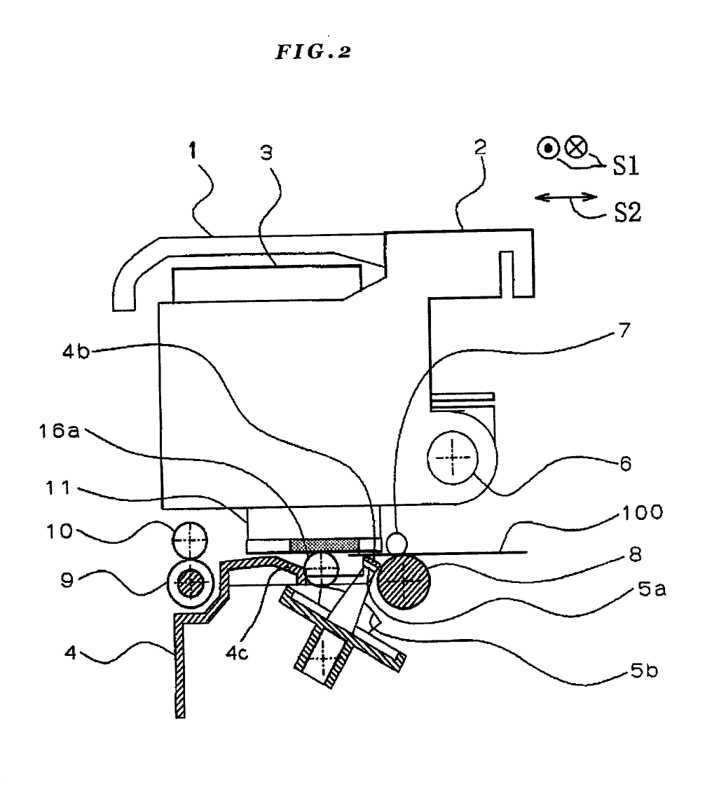

As shown in FIGS. 1 and 2, a recording head 11 is fixed to a carriage 2. An ink tank 3 is held on the carriage 2 by a tank lever 1. Also, the carriage 2 is supported on a guide shaft 6 so as to reciprocate in a main scanning direction indicated by an arrow S1.

A feed roller 8 is located at upstream of the recording head 11 in a sub scanning direction indicated by an arrow S2. Then, a paper 100 is sandwiched between the feed roller 8 and a pressure roller 7, and the feed roller 8 feeds the paper 100 in a sub scanning direction.

Driving force is transmitted to the feed roller 8 through an LF motor gear 13, an LF gear 14 and a large gear 17b of a feed roller gear from an LF motor 12, and the feed roller 8 is rotated.

A discharging roller 9 is located at downstream of the recording head 11 in the sub scanning direction. Then, the paper 100 is sandwiched between the discharging roller 9 and a discharging pressure roller 10, and the discharging roller 9 feeds the paper 100 in the sub scanning direction.

Driving force is transmitted to the discharging roller 9 through the LF motor gear 13, the LF gear 14 and a discharging roller gear 15 from the LF motor 12, and the discharging roller 9 is rotated.

Also, a main paper guide 4 is fixed between the feed roller 8 and the discharging roller 9. The main paper guide 4 supports the paper 100.

A sub paper guide 5 is rotatably held below the main paper guide 4. A protrusion 5a of the sub paper guide 5 protrudes from a plurality of holes 4a formed in the main paper guide 4 and supports the paper 100. At this time, a top surface (support surface) of the protrusion 5a is located at the same height position of a highest point of the feed roller 8.

The sub paper guide 5 is rotated by the driving force transmission in the order of the feed roller 8, a small gear 17a of the feed roller gear, a large gear 16b and a small gear 16a of a paper guide gear 16 and a friction plate (cam) 5b. The small gear 16a of the paper guide gear 16 and the friction plate 5b of the sub paper guide 5 are usually in contact with each other, and the driving force is transmitted through the frictional force. When the sub paper guide 5 is rotated to a predetermined position to come in contact with the main paper guide 4 and its rotation is stopped, the small gear 16a and the friction plate 5b are slipped, and the driving force is not transmitted.

[Explanation of Operation]

Operations of a feature portion in this ink jet printer will be described below.

As shown in FIGS. 1 and 2, after the paper 100 is fed by the feed roller 8 and the pressure roller 7 is fed to the vicinity of the discharging roller 9 for the present, it is returned back to a position of an end 4b of the main paper guide 4. That is, the paper 100 is placed at a print position at a top end.

In the above-mentioned process, the reverse rotation of the feed roller 8 enables its rotation to be transmitted through the small gear 17a of the feed roller gear 17 and the large gear 16b and the small gear 16a of the paper guide gear. Accordingly, the sub paper guide 5 is rotated. Thus, a sub paper guide protrusion 5a is concealed below the end 4b of the main paper guide 4 and the paper 100.

As shown in FIG. 2, the end 4b of the main paper guide 4 and the top surface of the protrusion 5a of the sub paper guide 5 are both concealed below the paper 100 upstream of the sub scanning direction from a front end of the paper 100. On the other hand, in the ink discharging range of the recording head 11 and the region downstream of the sub scanning direction from the front end of the paper 100, an inclination portion 4c of the main paper guide 4 and the other portions are located at the height positions lower than the highest point of the feed roller 8. Also, in the sub paper guide 5, a root portion that is never in contact with the paper 100 is only faced through the holes 4a.

Under this condition, the non-blank printing operation in the front end of the paper 100 is carried out. When a print data has a size larger than a paper size, if the printing operation is done in accordance with this print data, the ink discharged from the recording head 11 out from the front end of the paper 100. Although the ink out from the paper is deposited on the inclination portion 4c and the other portions of the main paper guide 4 and the root portion of the sub paper guide 5 through the holes 4a, those portions are always located at the position lower than the highest point of the feed roller 8 (the back surface of the paper 100). Thus, the paper 100 is never contaminated by the ink depositing on those portions.

After the completion of the printing operation in the top end of the paper 100, the feed roller 8 is rotated in a normal direction in order to gradually feed the paper 100. Thus, the sub paper guide 5 is also rotated in the normal direction in synchronization with the rotation of the feed roller 8.

Thus, the protrusion 5a of the sub paper guide 5 is protruded upwardly through the hole 4a of the main paper guide 4. Then, the top surface of the protrusion 5a comes in contact with the back surface of the paper 100, and it holds the paper 100.

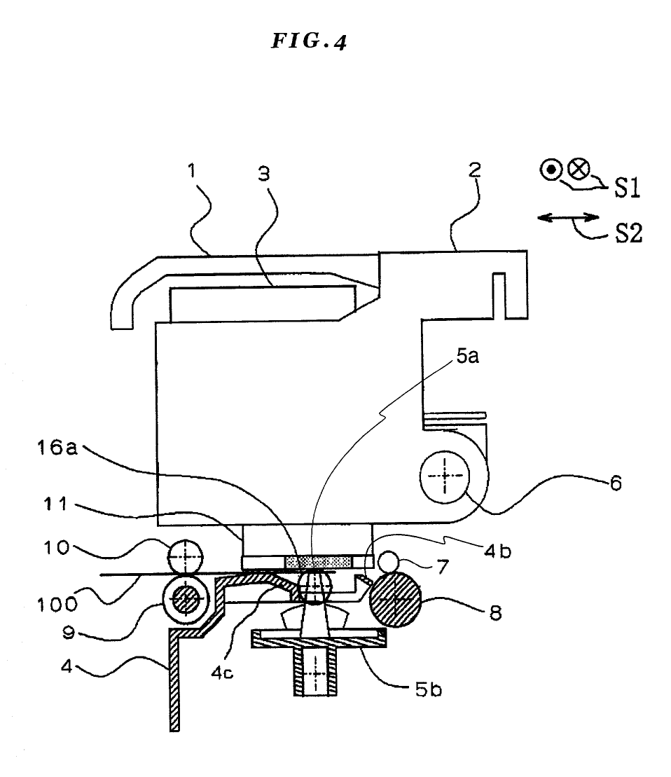

When the sub paper guide 5 comes in contact with the main paper guide 4 and its rotation is stopped, it is stopped in a state shown in FIG. 4. While the paper 100 is fed to the print position at the bottom end, the driving force is always transmitted to the sub paper guide 5 from the feed roller 8. However, while the rotation of the sub paper guide is limited by the main paper guide 4, the paper guide gear 16a and the sub paper guide friction plate 5b are slipped. Thus, the driving force is not transmitted to the sub paper guide 5 from the feed roller 8.

As shown in FIG. 4, the inclination portion 4c of the main paper guide 4 and the top surface of the protrusion 5a of the sub paper guide 5 are both concealed below the paper 100 at downstream of the sub scanning direction from a rear end of the paper 100. On the other hand, in the ink discharging range of the recording head 11 and the region upstream of the sub scanning direction from the rear end of the paper 100, the main paper guide 4 is located at the height position lower than the highest point of the feed roller 8. Also, the root portion of the sub paper guide 5 which is never in contact with the paper 100 is only faced through the holes 4a.

Under this condition, the non-blank printing operation in the rear end of the paper 100 is carried out. When the print data has the size larger than the paper size, if the printing operation is done in accordance with this print data, the ink discharged from the recording head 11 out from the rear end of the paper 100. Although the ink out from the paper is deposited on a part of the main paper guide 4 and root portion of the sub paper guide 5 through the holes 4a of the main paper guide 4, those portions are always located at the position lower than the highest point of the feed roller 8 (the back of the paper 100). Thus, the paper 100 is never contaminated by the ink depositing on that part.

Here, the sub paper guide is rotated in this embodiment. However, it is acceptable straightly movement in the present invention.

Also, the ink out from the paper and unnecessary ink may be absorbed or gathered and retained and then exhausted or recycled. For example, a sponge material is placed in the main paper guide located at the height position lower than the highest point of the feed roller and the root portion that is never in contact with the paper of the sub paper guide, in the ink discharging range of the recording head.

In the paper guide of the ink jet printer according to the present invention, the main paper guide has the top surface expanded over the inner and outer regions of the ink discharging range of the recording head; and the holes formed in at least the ink discharging range on the top surface of the main paper guide, and the sub paper guide has the protrusion that is protruded upwardly through the hole of the main paper guide and is movable along the sub scanning direction, and the protrusion has at the tip the support plane for supporting the back surface of the paper, and the sub paper guide is further moved such that the support plane is always located below the paper depending on the position in the sub scanning direction of the paper. Thus, even if the printing operation is done in the print data having the size larger than the paper size in order to perform the non-blank printing operation on the top and bottom ends of the paper, the ink out from the paper never be deposited on the paper guide portion for coming in contact with the paper and holding the paper. Hence, the paper is never contaminated. Therefore, without worrying about the positional deviation of the paper and the difference of the paper size, it is possible to carry out the non-blank printing operation.

The invention may be embodied in other specific forms without departing from the spirit or essential characteristic thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2001-119405 (Filed on Apr. 18^{th}, 2001) including specification, claims, drawings and summary are incorporated herein by reference in its entirety.

What is claimed is:

1. An ink jet printer comprising:
a recording head for discharging ink;
a carriage for moving said recording head in a main scanning direction; and
a paper feeding mechanism for feeding a paper in a sub scanning direction perpendicular to said main scanning direction, wherein said paper feeding mechanism has a feed roller for supporting a back surface of the paper and feeding it in said sub scanning direction and a paper guide for supporting said paper at downstream of the sub scanning direction of said feed roller,
wherein said paper guide is provided with a main paper guide and a sub paper guide,
said main paper guide has a top surface expanded over inner and outer regions of an ink discharging range of said recording head; and holes formed in at least said ink discharging range on said top surface,
said sub paper guide has a protrusion that is protruded upwardly through said hole of said main paper guide and is movable along said sub scanning direction,
said protrusion has a support plane for supporting a back surface of the paper at a tip, and
said support plane of said sub paper guide is further moved so as to be always located below the paper, depending on a position in said sub scanning direction of the paper.

2. An ink jet printer according to claim 1, wherein a movable range of said protrusion of said sub paper guide is limited by a contact between said main paper guide and said sub paper guide.

3. An ink jet printer according to claim 1,
wherein said sub paper guide has a friction plate;
said friction plate is in direct or indirect contact with said feed roller; and
said sub paper guide is moved in synchronization with a rotation of the feed roller.

4. An ink jet printer according to claim 2,
wherein said sub paper guide has a friction plate;
said friction plate is in direct or indirect contact with said feed roller; and
said sub paper guide is moved in synchronization with a rotation of the feed roller.

5. An ink jet printer according to claim 3, wherein said friction plate releases a driving force from said feed roller, while said sub paper guide is in contact with said main paper guide.

6. An ink jet printer according to claim 4, wherein said friction plate releases a driving force from said feed roller, while said sub paper guide is in contact with said main paper guide.

7. An ink jet printer according to claim 1, further including a ink absorbing body for absorbing excessive ink that is discharged from said recording head and out from a paper, on said top surface of said main paper guide existing in an ink discharging range of said recording head and a region except said support plane in a surface of said sub paper guide existing in the ink discharging range of the recording head.

8. An ink jet printer according to claim 2, further including a ink absorbing body for absorbing excessive ink that is discharged from said recording head and out from a paper, on said top surface of said main paper guide existing in an ink discharging range of said recording head and a region except said support plane in a surface of said sub paper guide existing in the ink discharging range of the recording head.

9. An ink jet printer according to claim 3, further including a ink absorbing body for absorbing excessive ink that is discharged from said recording head and out from a paper, on said top surface of said main paper guide existing in an ink discharging range of said recording head and a region except said support plane in a surface of said sub paper guide existing in the ink discharging range of the recording head.

10. An ink jet printer according to claim 4, further including a ink absorbing body for absorbing excessive ink that is discharged from said recording head and out from a paper, on said top surface of said main paper guide existing in an ink discharging range of said recording head and a region except said support plane in a surface of said sub paper guide existing in the ink discharging range of the recording head.

11. An ink jet printer according to claim 5, further including a ink absorbing body for absorbing excessive ink that is discharged from said recording head and out from a paper, on said top surface of said main paper guide existing in an ink discharging range of said recording head and a region except said support plane in a surface of said sub paper guide existing in the ink discharging range of the recording head.

12. An ink jet printer according to claim 6, further including a ink absorbing body for absorbing excessive ink that is discharged from said recording head and out from a paper, on said top surface of said main paper guide existing in an ink discharging range of said recording head and a region except said support plane in a surface of said sub paper guide existing in the ink discharging range of the recording head.

13. An ink jet printer according to claim 1,
wherein said top surface of said main paper guide is expanded in a position lower than a highest point of said feed roller; and
said protrusion can be rotated along said sub scanning direction.

14. An ink jet printer according to claim 2,
wherein said top surface of said main paper guide is expanded in a position lower than a highest point of said feed roller; and
said protrusion can be rotated along said sub scanning direction.

15. An ink jet printer according to claim 3,
wherein said top surface of said main paper guide is expanded in a position lower than a highest point of said feed roller; and
said protrusion can be rotated along said sub scanning direction.

16. An ink jet printer according to claim 5,
wherein said top surface of said main paper guide is expanded in a position lower than a highest point of said feed roller; and
said protrusion can be rotated along said sub scanning direction.

17. An ink jet printer according to claim 7,
wherein said top surface of said main paper guide is expanded in a position lower than a highest point of said feed roller; and
said protrusion can be rotated along said sub scanning direction.
